(19) United States
(12) Patent Application Publication
(10) Pub. No.: US 2025/0289691 A1
(43) Pub. Date: Sep. 18, 2025

(54) TRANSPORTABLE LIFT APPARATUSES FOR REMOVABLE VEHICLE COMPONENTS

(71) Applicant: Bryan Hamilton, Battle Ground, WA (US)

(72) Inventor: Bryan Hamilton, Battle Ground, WA (US)

(21) Appl. No.: 19/039,640

(22) Filed: Jan. 28, 2025

Related U.S. Application Data
(60) Provisional application No. 63/564,981, filed on Mar. 13, 2024.

(51) Int. Cl. B66C 23/44; B60J 7/10; B66C 23/42; B66D 1/04

(52) U.S. Cl. CPC B66C 23/44; B60J 7/106; B66C 23/42; B66D 1/04; B66C 2700/0378

(57) ABSTRACT

Lift apparatus for selectively lifting and storing removable components of a convertible vehicle. The lift apparatuses including a frame and a lift mechanism. The frame is configured to removably mount to a tow hitch of a towing vehicle. The frame includes a base, a post, and a boom. The base is configured to removably mount to the tow hitch. The post extends vertically from the base. The boom is pivotally mounted to the post and configured to pivot between a travel position where the boom is aligned with the post and a lift position where the boom extends transverse to the post. The lift mechanism is operatively supported on the frame and configured to selectively lift a removable top of the convertible vehicle.

### CROSS REFERENCE TO RELATED APPLICATIONS

This application claims priority to copending U.S. Application, Ser. No. 63/564,981, filed on Mar. 13, 2024, which is hereby incorporated by reference for all purposes.

### BACKGROUND

The present disclosure relates generally to lift apparatuses. In particular, lift apparatuses for selectively lifting, storing, and installing removable vehicle components, such as removable tops and doors, are described.

Convertible vehicles (“convertibles”) are a popular type of vehicle that allow one to drive with less separation from the outside environment. Convertibles typically have removable tops. Convertible sport utility vehicles, such as Jeep™ Wrangler™ vehicles, often have removable doors as well as removable tops.

Convertibles are often towed behind motorhomes to be used once a motorhome is parked at desired destination. It is typically best to tow convertibles with removable components installed on the vehicle to safeguard the interior of the vehicle from road grime, rain, and other damaging elements. Towing convertibles with removable components installed also helps keep interior contents of the convertible more secure.

While towing convertibles with tops and doors installed is prudent, selectively removing the top and doors at a remote destination is challenging. The removable top and doors tend to be heavy and awkward to manipulate. Currently, there is no simple way to remove tops and doors of convertibles when away from home. Further, there is no convenient place to store tops and doors at remote locations after they are selectively removed.

Lift apparatuses exist for lifting heavy vehicle components, such as engine hoists and floor cranes. However, such conventional lift apparatuses are large, heavy, and generally unsuitable for transporting to different destinations.

It would be desirable to have a lift apparatus that could be easily transported to different destinations. Further, it would be beneficial if a lift apparatus could be towed to a destination behind a motorhome or other towing vehicle. Even more advantageous would be a lift apparatus that could be towed to a destination while accommodating a convertible vehicle towed to the destination at the same time.

It would be convenient if a lift apparatus could not only assist with lifting removable components, but also to provide a place to store the components removed as well. Ideally, the lift apparatus would store removable components in a compact and stable configuration. Further, it would be helpful if the lift apparatus itself could be compactly configured when not in use.

A lift apparatus that enabled a single person to selectively remove and store removable components would be especially advantageous. It would be beneficial if the lift apparatus enabled a person to quickly remove or install components as needed, such as when rapid weather changes necessitated installing a top and doors to protect the interior of the convertible.

Thus, there exists a need for lift apparatuses that improve upon and advance the design of known lift apparatuses and that provide solutions not currently provided. Examples of new and useful lift apparatuses relevant to the needs existing in the field are discussed below.

### SUMMARY

The present disclosure is directed to lift apparatuses for selectively lifting and storing removable components of a convertible vehicle. The lift apparatuses include a frame and a lift mechanism.

The frame is configured to removably mount to a tow hitch of a towing vehicle. The frame includes a base, a post, and a boom. The base is configured to removably mount to the tow hitch. The post extends vertically from the base. The boom is pivotally mounted to the post and configured to pivot between a travel position where the boom is aligned with the post and a lift position where the boom extends transverse to the post.

The lift mechanism is operatively supported on the frame and configured to selectively lift a removable top of the convertible vehicle.

### BRIEF DESCRIPTION OF THE DRAWINGS

FIG. 1 is a perspective view of a first example of a lift apparatus lifting a removable top of a vehicle.

FIG. 2 is a perspective view of the lift apparatus shown in FIG. 1 in a travel configuration.

FIG. 3 is a side elevation view of the lift apparatus shown in FIG. 1 mounted to a tow hitch of a towing vehicle and coupling a towed vehicle to the towing vehicle.

FIG. 4 is a side elevation view of a base of the lift apparatus shown in FIG. 1 depicting a base tongue adapted to insert into a tow hitch recess of a tow hitch of a towing vehicle and a receiver hitch adapted to receive a towbar or a ball mount.

FIG. 5 is a rear elevation view of the lift apparatus shown in FIG. 1 with a vehicle door supported on a door support assembly.

FIG. 6 is a top view of the lift apparatus shown in FIG. 1.

FIG. 7 is a perspective view of a second example of a lift apparatus in a lift configuration.

FIG. 8 is a perspective view of the lift apparatus shown in FIG. 7 in a travel configuration.

FIG. 9 is a rear elevation view of the lift apparatus shown in FIG. 7 with doors mounted to a door support assembly of the lift apparatus.

FIG. 10 is a side elevation view of a third example of a lift apparatus.

### DETAILED DESCRIPTION

The disclosed lift apparatuses will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various lift apparatuses are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

### Contextual Details

Ancillary features relevant to the lift apparatuses described herein will first be described to provide context and to aid discussing the lift apparatuses.

### Vehicles

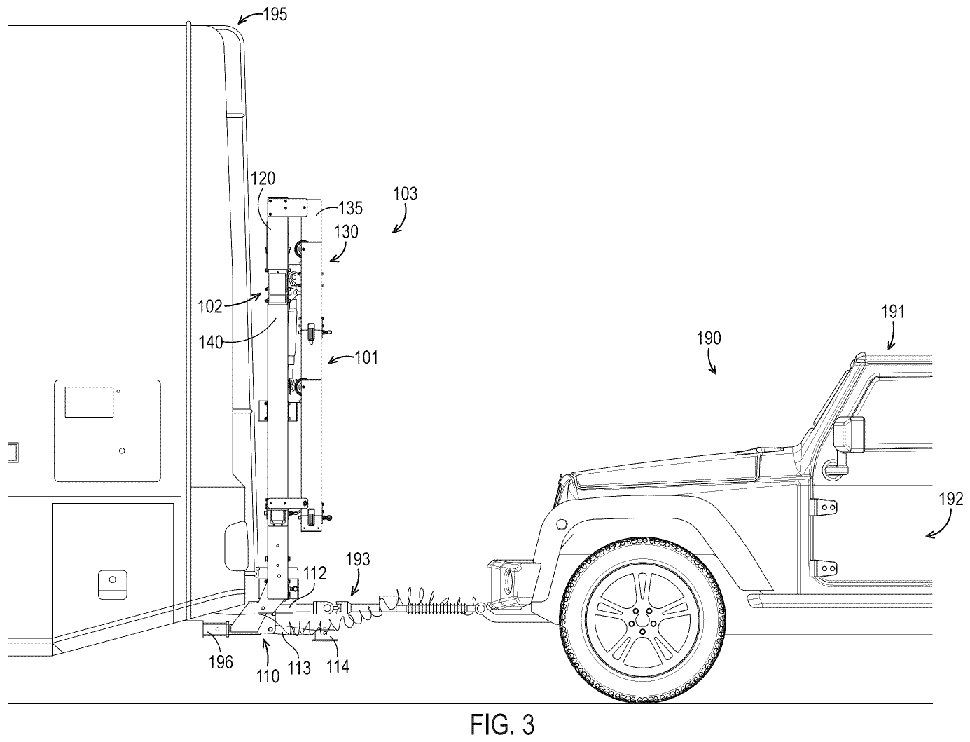

The lift apparatuses discussed in this document are used with vehicles, including towing vehicles and convertible vehicles, which may be towed by the towing vehicle. In particular, the lift apparatuses function to assist with selectively removing, storing, and installing removable components of convertible vehicles towed to different destinations. Further, as shown in FIG. 3, the lift apparatuses are configured to mount to a towing vehicle to be available for use in different locations.

The lift apparatuses may be used with a wide variety of convertible vehicles, such as convertible sport utility vehicles, sedans, roadsters, and trucks. A Jeep™ Wrangler™ sport utility vehicle is depicted in FIG. 3 as an example convertible vehicle 190. The lift apparatuses discussed below may be used with any currently known or later developed type of convertible vehicle.

Suitable convertible vehicles will have one or more removable components, such as removable doors and/or tops. The removable tops may be rigid, which are commonly referred to as hard tops. Convertible vehicle 190 shown in FIG. 3 has a removable top 191 and removable doors 192. The lift apparatuses may be used to assist with manipulating and storing any currently known or later developed type of removable component of a convertible vehicle.

The lift apparatuses may be used with many different types of towing vehicle. For example, the lift apparatuses may be used with motorhomes, recreational vehicles, campers, sport utility vehicles, trucks, and the like. In the example shown in FIG. 3, a lift apparatus 100 is mounted to a towing vehicle 195, which is a motorhome. The lift apparatuses discussed below may be used with any currently known or later developed type of towing vehicle.

The lift apparatuses are typically used in scenarios where a towing vehicle is towing a convertible, which may be referred to as a towed vehicle. The lift apparatuses mount to the towing vehicle towing a convertible and assist with selectively removing, storing, and installing removable components of the convertible at a given destination.

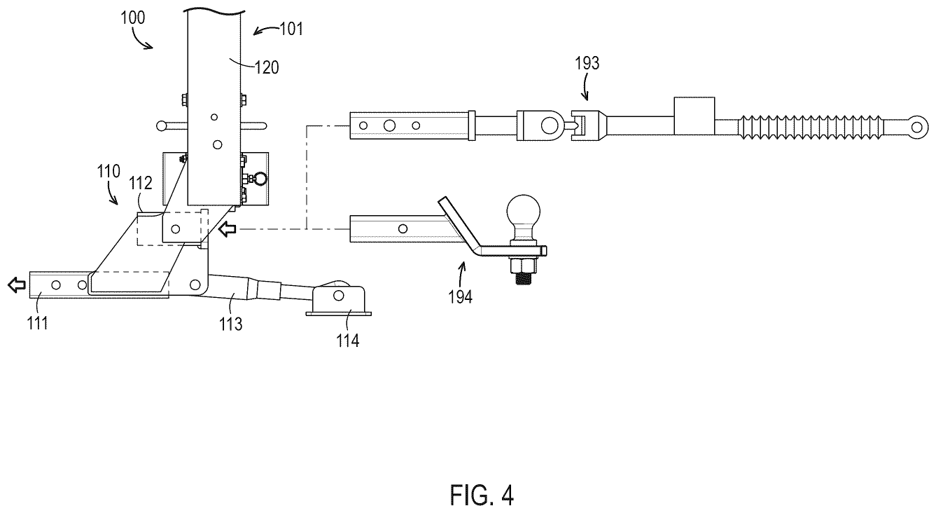

As shown in FIGS. 3 and 4, lift apparatus 100 is mounted to towing vehicle 195 in a manner that allows convertible vehicle 190 to be towed by towing vehicle 195. Towing vehicle 195 includes a tow hitch 196 and lift apparatus 100 selectively mounts to tow hitch 196. As shown in FIGS. 3 and 4 and discussed in more detail below, a towbar 193 or a ball mount 194 linked to convertible vehicle 190 may be used to selectively couple to lift apparatus 100. Towbar 193 or ball mount 194 linking to lift apparatus 100 and convertible vehicle 190 mechanically couples convertible vehicle 190 to towing vehicle 195 because lift apparatus is coupled to tow hitch 196 of towing vehicle 195.

### Transportable Lift Apparatuses For Removable Vehicle Components

With reference to the figures, transportable lift apparatuses for removable vehicle components will now be described. The lift apparatuses discussed herein function to lift and store removable components of convertible vehicles, such as removable tops and doors. The lift apparatuses are configured to mount to a towing vehicle to be available for use in different destinations.

The reader will appreciate from the figures and description below that the presently disclosed lift apparatuses address many of the shortcomings of conventional lift apparatuses. Further, the novel lift apparatuses discussed herein provide unique solutions to challenges currently existing for removing components from convertible vehicles in remote locations.

For example, the novel lift apparatus discussed in this document are comparatively small, light, and well-suited to being transported to different destinations. Beneficially, the novel lift apparatuses can be towed to a destination behind a motorhome or other towing vehicle. A further advantage of the novel lift apparatuses is that they can be towed to a destination while accommodating a convertible vehicle towed to the destination at the same time.

Conveniently, the novel lift apparatuses disclosed herein not only assist with lifting removable components of convertibles, but also provide a place to store the components removed as well. The novel lift apparatuses store removable components in a compact and stable configuration. Helpfully, the novel lift apparatuses themselves can be compactly configured when not in use.

Importantly, the novel lift apparatuses presented in this document enable a single person to selectively remove, store, and install removable components of convertible vehicles. Beneficially, the novel lift apparatuses enable a person to quickly remove or install components as needed, such as when rapid weather changes necessitate installing a top and doors to protect the interior of the convertible.

### Lift Apparatus Embodiment One

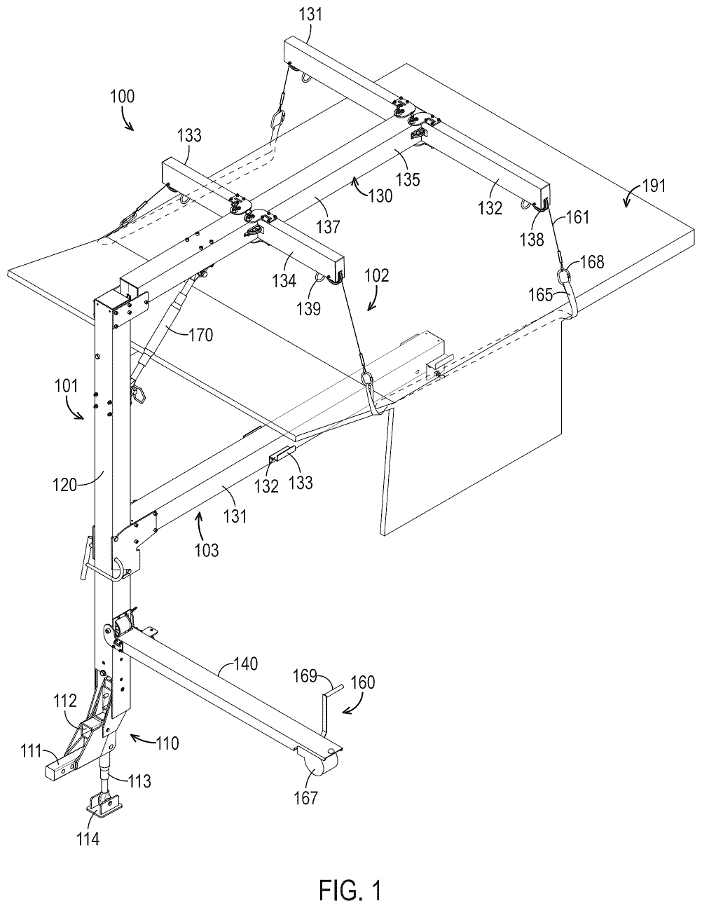

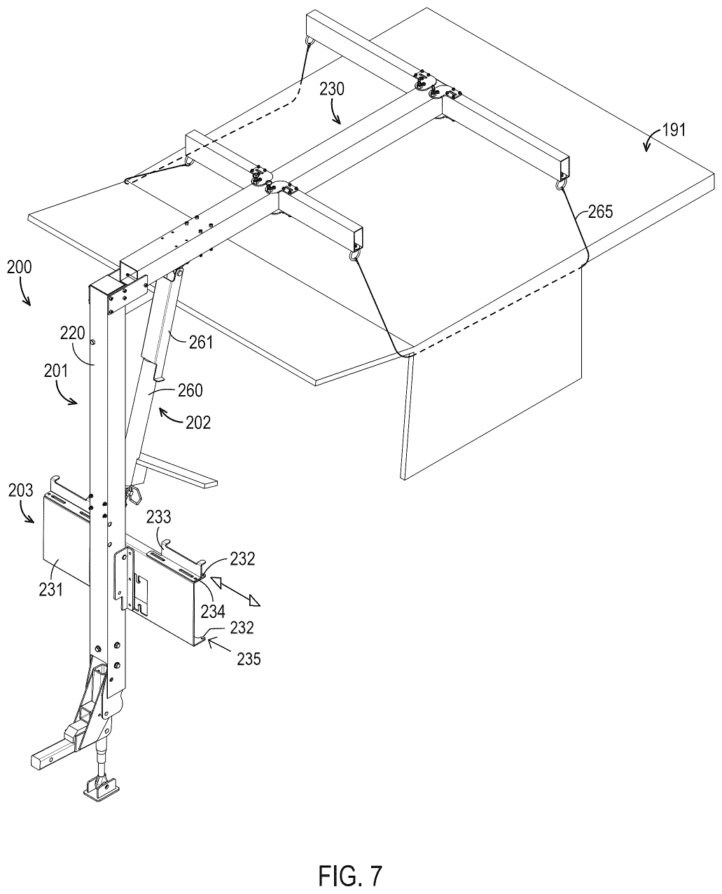

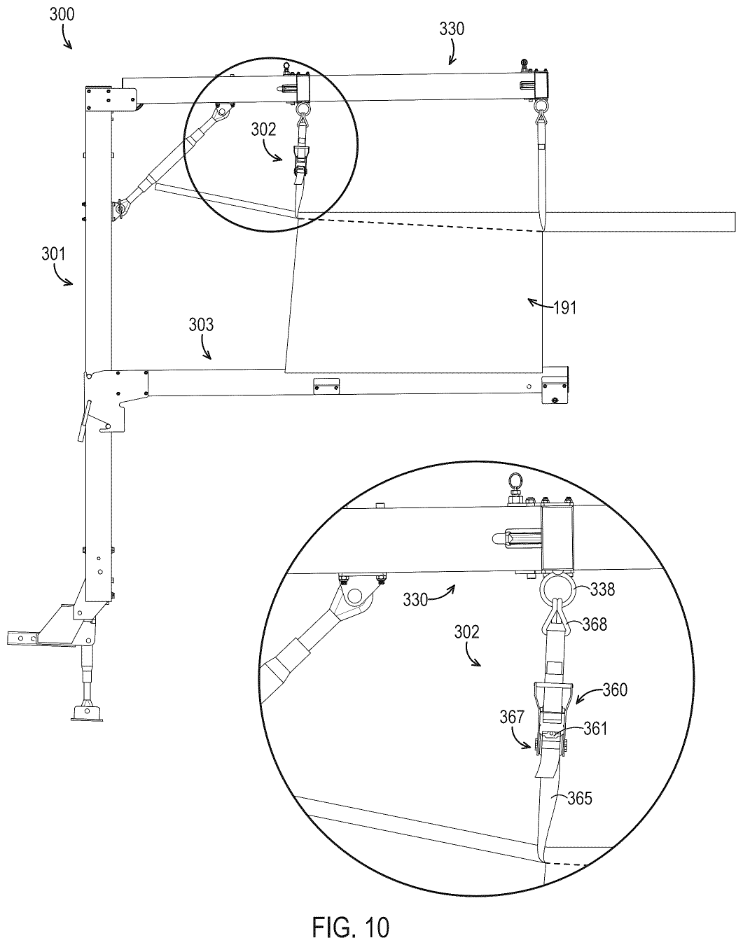

With reference to FIGS. 1-6, a first example of a lift apparatus, lift apparatus 100, will now be described. A second example of a lift apparatus, lift apparatus 200, is depicted in FIGS. 7-9 and discussed in the Embodiment Two section below. A third example of a lift apparatus, lift apparatus 300, is depicted in FIG. 10 and discussed in the Embodiment Three section below.

With reference to FIG. 1, the reader can see that lift apparatus 100 includes a frame 101, a lift mechanism 102, and a door support assembly 103. In some examples, the lift apparatus does not include one or more features included in lift apparatus 100, such as not including a door support assembly. In other examples, the lift apparatus includes additional or alternative features.

The size and shape of the lift apparatus may differ than depicted in FIGS. 1-6. For example, the lift apparatus may be larger or smaller relative to convertible vehicle 190 and/or towing vehicle 195.

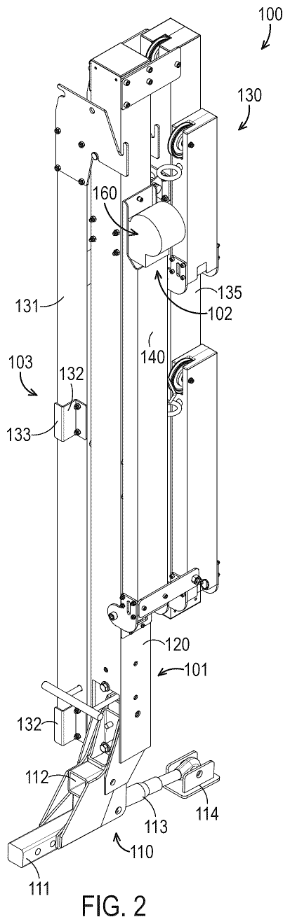

By comparing different figures in FIGS. 1-3, 5, and 6, the reader can see that lift apparatus 100 is configured to move between a use configuration and a stowed configuration. The use configuration is shown in FIGS. 1, 5, and 6 and the stowed configuration is shown in FIGS. 2 and 3. The stowed configuration is compact relative to the use configuration. The compact stowed configuration is well-suited to transporting lift apparatus 100 to different destinations, such as depicted in FIG. 3.

### Frame

Frame 101 functions to support lift mechanism 102 and door support assembly 103. Further, frame 101 serves to selectively couple lift apparatus 100 to towing vehicle 195. Further, frame 101 enables lift apparatus 100 to selectively move between the stowed configuration and the use configuration to facilitate transport and use with the convertible vehicle, respectively.

With reference to FIGS. 3 and 4, the reader can see that frame 101 is configured to removably mount to towing vehicle 195. In particular, frame 101 removably mounts to tow hitch 196 of towing vehicle 195. The reader can see in FIGS. 3 and 4 and frame 101 mounting to tow hitch 196 does not prevent convertible vehicle 190 from also coupling to towing vehicle 195.

As shown in FIGS. 1-6, frame 101 includes a base 110, a post 120, a boom 130, a winch arm 140, and a brace 170. However, the frame may include additional, fewer, or alternative components in other examples. For example, some frame examples do not include a winch arm. The components of frame 101 are discussed in the sections below.

### Base

Base 110 facilitates selectively mounting frame 101 to towing vehicle 195. Base 110 also supports post 120. Base 110 further selectively stabilizes lift apparatus 100 from the ground by pivoting a support leg 113 from a stowed position to a deployed position in contact with the ground

In the present example, as shown in FIGS. 3 and 4, base 110 is configured to removably mount to tow hitch 196 of towing vehicle 195. Base 110 defines a base tongue 111 to facilitate removably mounting to tow hitch 196. As represented with an arrow in FIG. 4, base tongue 111 is adapted to insert into a tow hitch recess of tow hitch 196.

Base tongue 111 inserting into the tow hitch recess of tow hitch 196 selectively couples base 110 to tow hitch 196. Base 110 coupling to tow hitch 196 couples lift apparatus 100 to towing vehicle 195. Base tongue 111 may be selectively removed from the tow hitch recess of tow hitch 196 to selectively decouple lift apparatus 100 from towing vehicle 195 as well.

Significantly, base 110 is configured to enable convertible vehicle 190 to mechanically couple to towing vehicle 195 when lift apparatus 100 is selectively coupled to tow hitch 196. As shown in FIGS. 3 and 4, base 110 includes a receiver hitch 112 to facilitate mechanically linking convertible vehicle 190 with towing vehicle 195. Receiver hitch 112 is mounted to base tongue 111.

As demonstrated in FIGS. 3 and 4, receiver hitch 112 is configured to receive a towbar 193 or a ball mount 194 to selectively link convertible vehicle 190 to towing vehicle 195. Convertible vehicles may utilize either towbars or ball mounts to link to towing vehicles. Base 110 of lift apparatus 100 accommodates either towbar or ball mount linking approaches. For example, FIG. 3 demonstrates convertible vehicle 190 linked to towbar 193 and towbar 193 inserted into receiver hitch 112 to selectively link convertible vehicle 190 to towing vehicle 195. The base may be configured to selectively couple to a convertible vehicle for towing purposes by any currently known or later developed means.

With reference to FIGS. 1-5, the reader can see that base 110 includes a support leg 113 and a support foot 114. Support leg 113 is pivotally mounted on base 110 to enable it pivoting between a stowed position and a deployed position. The stowed position of support leg 113 is shown in FIGS. 3 and 4 and has support foot 114 raised off the ground. The deployed position of support leg 113 is shown in FIGS. 1, 2, and 5 and has support foot 114 in contact with the ground.

### Post

Post 120 supports boom 130, a door support assembly 103, and winch arm 140. Boom 130 is pivotally mounted to post 120 on an end of post 120 opposite base 110. As shown in FIGS. 1-6, post 120 extends vertically from base 110.

In the present example, post 120 is formed from metal in a square tube shape. However, the size, shape, and material of construction of the post may vary in different examples. Other suitable materials include wood, polymers, and composite materials.

### Boom

Boom 130 supports components of lift mechanism 102 in a position above convertible vehicle 190. Boom 130 supporting lift mechanism 102 above convertible vehicle 190 facilitates removing and lifting removable top 191 and removable doors 192.

As shown in FIGS. 1-3, boom 130 is pivotally mounted to post 120. Comparing FIG. 1 to FIGS. 2 and 3, the reader can see that boom 130 is configured to pivot between a travel position and a lift position. In the travel position shown in FIGS. 2 and 3, boom 130 is aligned with post 120 to render lift apparatus 100 more compact. In the lift position shown in FIGS. 1, 5, and 6, boom 130 extends transverse to post 120. When extending transverse to post 120, convertible vehicle 190 can be positioned underneath boom 130 and underneath components of lift mechanism 102 supported on boom 130.

As shown in FIGS. 1, 5, and 6, boom 130 includes cross members 131-134, a primary member 135, and mounting points 139. Primary member 135 extends longitudinally from post 120. As apparent from FIGS. 1, 5, and 6, primary member 135 has a first lateral side 136 and a second lateral side 137 opposite first lateral side 136.

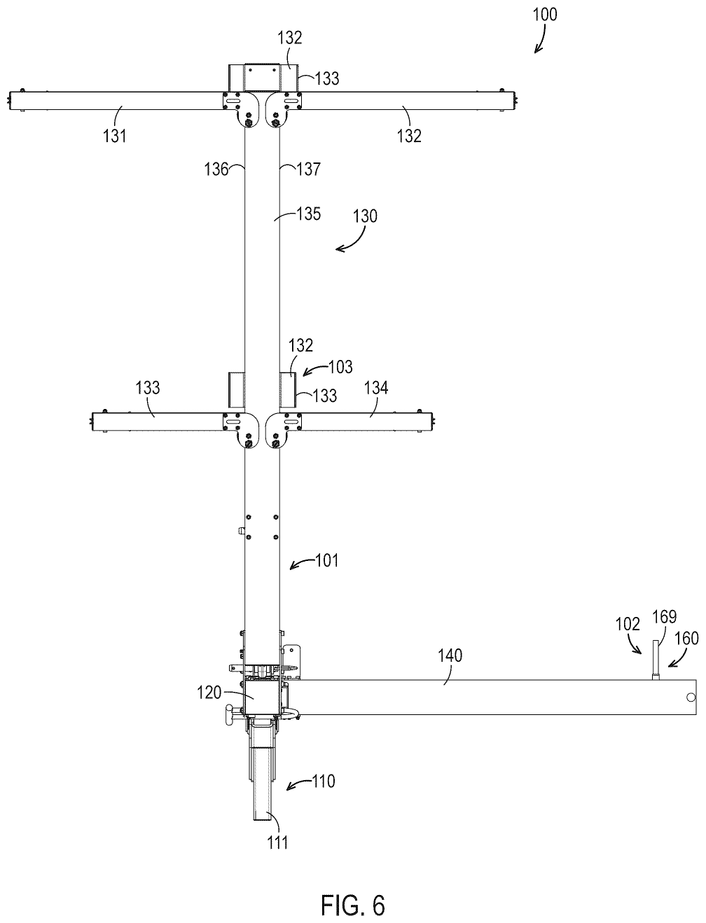

First cross member 131 is mounted to first lateral side 136 of primary member 135. In particular, as depicted in FIG. 6, first cross member 131 is pivotally mounted to primary member 135 to enable moving between a compact and an extended position. In the compact position, first cross member 131 is aligned with primary member 135 proximate first lateral side 136. In the extended position, first cross member 131 extends laterally from primary member 135.

With continued reference to FIGS. 1, 5, and 6, second cross member 132 is pivotally mounted to primary member 135. Second cross member 132 is mounted to primary member 135 at the same longitudinal position on primary member 135 as first cross member 131, but on second lateral side 137 of primary member 135. Second cross member 132 extends laterally from primary member 135 in an extended position and is aligned with primary member 135 proximate second lateral side 137 in a compact position.

As depicted in FIGS. 1, 5, and 6, third cross member 133 is pivotally mounted to primary member 135 on first lateral side 136. Third cross member 133 is longitudinally spaced from first cross member 131. In a compact position, third cross member 133 is aligned with primary member 135 proximate first lateral side 136. In an extended position, third cross member 133 extends laterally from the primary member 135.

With further reference to FIGS. 1, 5, and 6, fourth cross member 134 is pivotally mounted to primary member 135. Fourth cross member 134 is longitudinally spaced from second cross member 132 on second lateral side 137 of primary member 135. Fourth cross member 134 extends laterally from primary member 135 in an extended position and is aligned with primary member 135 proximate second lateral side 137 in a compact position.

FIGS. 1, 5, and 6 demonstrate that boom 130 defines multiple, spaced lift points 138. Lift points 138 are located at ends of cross members 131-134. Lift points 138 facilitate lifting removable components from convertible vehicle 190 with stability by enabling lift mechanism 102 to lift removable components from spaced apart positions. In the present example, boom 130 defines four lift points 138, but may define additional or fewer lift points in other examples.

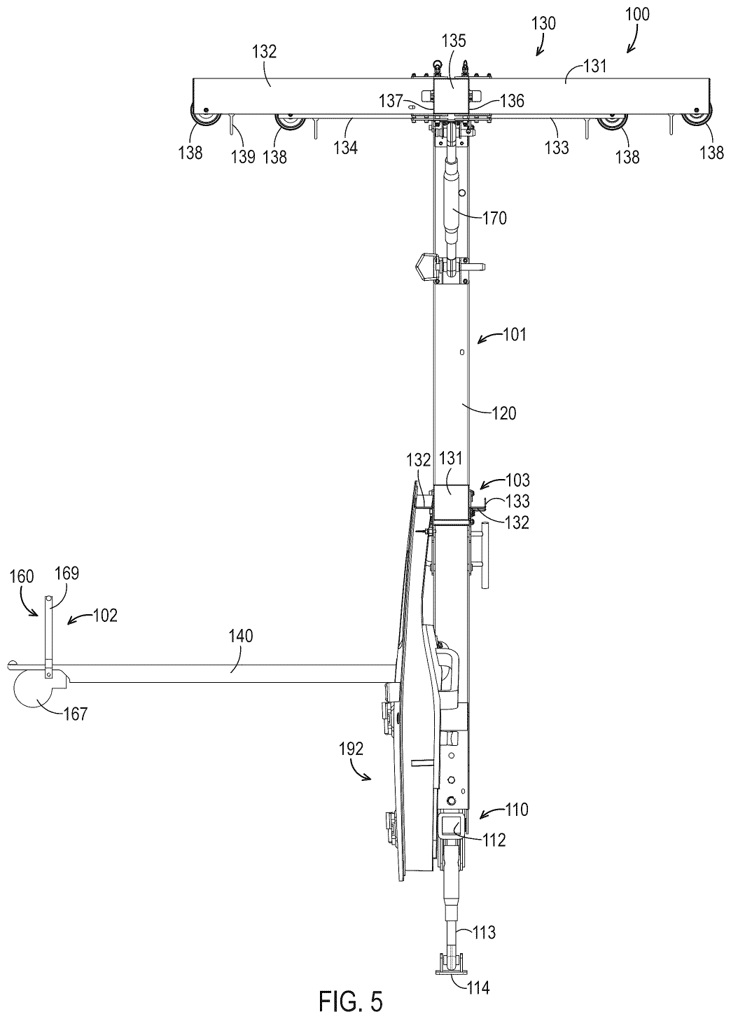

In the example shown in FIGS. 1 and 5, lift points 138 are pulleys configured to facilitate lifting removable components of convertible vehicle 190 with lift mechanism 102. In the present example, boom 130 includes four pulleys, but may include additional or fewer pulleys in other examples. Each pulley supports one of cables 161 of lift mechanism 102 as the cable selectively extends and retracts relative to boom 130 when removing and installing components of convertible vehicle 190.

Mounting points 139 are disposed on cross members 131-134. Mounting points 139 provide a place for securing components of convertible vehicle 190 after removing them without requiring lift mechanism 102 to retain the components. Expressed another way, the load of the removed components may be selectively transferred from lift mechanism 102 to boom 130 by securing the components to mounting points 139.

As shown in FIGS. 1, 2, and 5, mounting points 139 are metal rings or eyes coupled to cross members 131-134. Mounting points 139 are proximate lift points 138. The close proximity of mounting points 139 to lift point pulleys 138 makes it convenient to transfer the load of components removed from convertible vehicle 190 from lift mechanism 102 to boom 130. Mounting points 139 enable removable top 191 to be supported by boom 130 independent of lift mechanism 102.

### Winch Arm

Winch arm 140 functions to support winch 160 of lift mechanism 102. As shown in FIGS. 1, 2, 3, 5 and 6, winch 160 is mounted to winch arm 140 at an end of winch arm 140 opposite post 120.

In particular, winch arm 140 is pivotally mounted to post 120 to enable winch arm 140 to pivot between a use position and a stowed position. In the stowed position of winch arm 140 depicted in FIGS. 2 and 3, winch arm 140 is parallel to post 120, which contributes to lift apparatus 100 having a compact configuration when being towed or idle. The use position of winch arm 140 is shown in FIGS. 1, 5 and 6 and supports winch 160 in a convenient place to be operated by a user when removing or installing components of convertible vehicle 190 with lift mechanism 102.

### Brace

Brace 170 serves to support boom 130 in a desired position extended from post 120. As shown in FIGS. 1 and 5, brace 170 extends between boom 130 and post 120. Brace 170 is mounted to post 120 on one end and mounted to boom 130 on an opposite end.

In the present example, brace 170 is configured to allow boom 130 to selectively pivot to a stowed position parallel to post 120 as well. Brace 170 allows boom 130 to selectively pivot to the stowed position by retracting a brace arm within a brace housing. However, the brace may be a rigid member in some examples. In rigid member examples, the brace may be removably mounted between the post and the boom and removed when it is desired to pivot the boom towards the post.

In the present example, brace 170 is a strut. However, the brace may be any currently known or later developed type of brace.

### Lift Mechanism

Lift mechanism 102 configured to selectively lift components of convertible vehicle 190, such as removable top 191 and removable doors 192. Lift mechanism 102 may be used to lift or lower any removable component of convertible vehicle 190.

In the present example, lift mechanism 102 utilizes a winch mechanism, but other lift mechanisms are contemplated. For example, FIGS. 7-9 demonstrate a lift mechanism 202 that utilizes a linear actuator for lifting. FIG. 10 highlights a lift mechanism 302 that utilizes adjustable length straps. In some examples, a user manually pivots the boom of the lifting apparatus to lift and lower components of the convertible vehicle.

The reader can see in FIGS. 1-3, 5, and 6 that lift apparatus 102 is supported on frame 101. Different components of lift apparatus 102 are supported on different components of frame 101.

As apparent from FIGS. 1-3, 5, and 6, lift apparatus 102 includes a winch 160, cables 161, couplers 168, and straps 165. Winch 160 is supported on frame 101. In particular, winch 160 is supported on winch arm 140 at an end of winch arm 140 opposite post 120.

As shown in FIGS. 1-3, 5, and 6, winch 160 includes a spool 167. Cables 161 have first ends coupled to spool 167 and second ends opposite the first ends. The first ends are obscured by winch arm 140 and spool 167 and second ends are depicted in FIG. 1 hanging below pulleys 138. Couplers 168 couple to the second ends of cables 161 below pulleys 138.

Further, couplers 168 selectively couple to ends of straps 165. As shown in FIG. 1, straps 165 can be disposed underneath different portions of removable top 191 and coupled to couplers 168 on opposite sides of removable top 191. Straps 165 may be routed through window frames of open windows of removable doors 192 as well.

When straps 165 are disposed below removable top 191 (or through a removable door window frame) and linked to couplers 168, lift mechanism 102 can selectively raise and lower removable top 191 (or removable door 192). Raising and lowering components of convertible vehicle 190 with straps 165, couplers 168, and cables 161 is accomplished with winch 160.

In more detail, cables 161 are partially wound around spool 167 of winch 160. Rotating spool 167 with a handle 169 alters how far cables 161, couplers 168, and straps 165 extend below pulleys 138. Retracting cables 161 towards boom 130 by rotating spool 167 in one direction serves to raise components of convertible vehicle 190. Rotating spool 167 in the opposite direction extends cables 161, couplers 168, and straps 165 farther below boom 130 to lower components of convertible vehicle 190.

In the present example, straps 165 are used to engage removable top 191 or removable doors 192. Any form of elongate tension bearing member may be used in addition or alternatively to a strap. Suitable elongate tension bearing members include straps, chains, ropes, cables, and the like.

### Door Support Assembly

As shown in FIG. 5, door support assembly 103 functions to support one or more removable doors 192 of convertible vehicle 190. For example, a user may store removable doors 192 on door support assembly 103 after the user utilizes lift apparatus 100 to selectively remove removable doors 192 from convertible vehicle 190.

In the present example, door support assembly 103 includes a door support beam 131 and brackets 132. Brackets 132 are mounted to door support beam 131 in spaced locations. In the present example, as shown in FIGS. 1 and 6, two brackets 131 are mounted to each lateral side of door support beam 131 and brackets 132 on each lateral side of door support beam 131 are longitudinally spaced from each other.

Brackets 132 facilitate supporting four removable doors 192. As demonstrated in FIG. 5, removable door 192 rests on bracket 132. Brackets 132 are configured to retain and support from below a window frame of removable door 192 placed thereon. As apparent in FIG. 1, brackets 132 include a lip 133 designed to engage and retain a window frame of a removable door 192 like depicted in FIG. 5.

As shown in FIGS. 1 and 6, door support assembly 103 includes four brackets 132. However, other door support assembly examples may include additional or fewer brackets, including no brackets. Door support assemblies without brackets may support doors by hanging the doors from the door support beam directly. For example, a window of the removable door may be lowered to enable extending the door support beam through the open window frame and hanging the removable door from the door support beam by the open window frame resting on the door support beam.

As apparent by comparing FIGS. 1 and 2, door support assembly 103 is pivotally mounted to post 120. Pivotally mounting door support assembly 103 to post 120 enables moving door support assembly 103 between stowed and use positions correlating to the stowed and use configurations of lift apparatus 100. Door support assembly 103 is adapted to support removable door 192 when pivoted to extend transverse to post 120.

### Additional Embodiment

With reference to the figures not yet discussed, the discussion will now focus on additional lift apparatus embodiments. The additional embodiments include many similar or identical features to lift apparatus 100. Thus, for the sake of brevity, each feature of the additional embodiments below will not be redundantly explained. Rather, key distinctions between the additional embodiments and lift apparatus 100 will be described in detail and the reader should reference the discussion above for features substantially similar between the different lift apparatus examples.

### Second Embodiment

Turning attention to FIGS. 7-9, a second example of a lift apparatus, lift apparatus 200, will now be described. As can be seen in FIGS. 7-9, lift apparatus 200 includes a frame 201, a lift mechanism 202, and a door support assembly 203.

A distinction between lift apparatus 200 and lift apparatus 100 is that lift mechanism 202 includes an actuator 260 instead of a winch. Further, lift apparatus 200 does not include a brace between boom 230 and post 220 like lift apparatus 100. Instead, actuator 260 is disposed between boom 230 and post 220 and selectively supports boom 230 in a position pivoted away from post 220. Lift apparatus 200 also includes a safety member 261 that catches over an edge of actuator 260 to restrict boom 230 lowering unintentionally if actuator 260 loses pressure.

Actuator 260 is configured to selectively move boom 230 vertically by pivoting boom 230 relative to post 230. Actuator 260 moving boom 230 vertically effectuates lifting components of a convertible vehicle, such as removable top 191 depicted in FIG. 7, when boom 230 is linked to components of the convertible vehicle by elongate tension bearing members 265 passed under the component and selectively coupled to boom 230. As shown in FIG. 7, actuator 260 maintaining the position of boom 230 relative to post 220 retains removable top 191 on lift apparatus 200 for storage purposes.

In the example shown in FIGS. 7-9, actuator 260 is a linear actuator. In particular, actuator is a hydraulic ram. However, the actuator may be any currently known or later developed type of actuator, including linear actuators, screw jacks, hydraulic rams, and pneumatic pistons.

Door support assembly 203 is another distinction relative to lift apparatus 100. Door support assembly 203 does not include a door support beam like door support assembly 103, but instead includes a bracket 231 selectively mounted to post 220. In some examples, the door support assembly includes two or more brackets instead of a single, larger bracket like depicted in FIGS. 7-9. In some examples, the door support assembly includes individual brackets for each door supported.

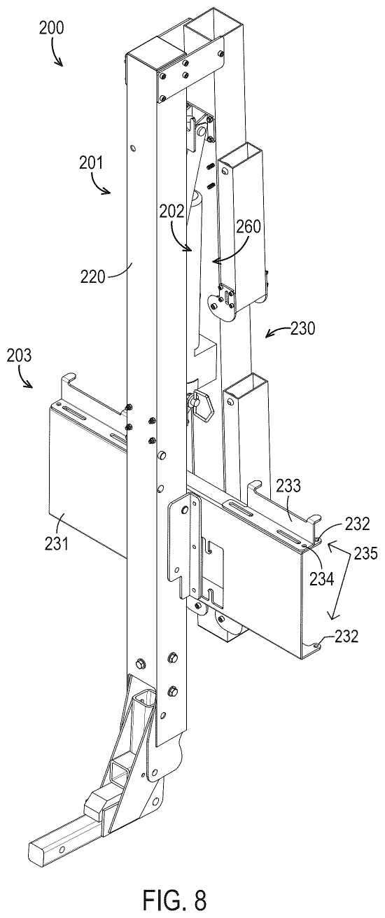

Bracket 231 includes a door coupler 235 to support removable doors 192 selectively removed from the convertible vehicle. In particular, as shown in FIGS. 7 and 8, door coupler 235 defines sets of vertically aligned receiver holes 292. Receiver holes 292 are configured to support removable doors 192 by vertically spaced hinge pins of removable doors 192.

Door coupler 235 shown in FIGS. 7 and 8 with sets of receiver holes 292 is configured to interface with vehicles like Jeep® Wrangler® vehicles, which have doors with projecting hinge pins when removed. However, the door coupler may be configured to interface with vehicles with doors that present hinge pin holes instead of hinge pins when the doors are removed, such as Ford® Bronco® vehicles. To accommodate vehicles with doors that present hinge pin holes, the door coupler may include sets of vertically aligned pins configured to insert into the hinge pin holes of the removed door.

As shown in FIGS. 7 and 8, door coupler 235 defines sets of vertically aligned receiver holes 292 adapted to receive hinge pins of one or more removable doors 192. Bracket 231 is configured to support removable door 192 when two vertically aligned hinge pins of removable door 192 are inserted into two vertically aligned receiver holes 292 of door coupler 295.

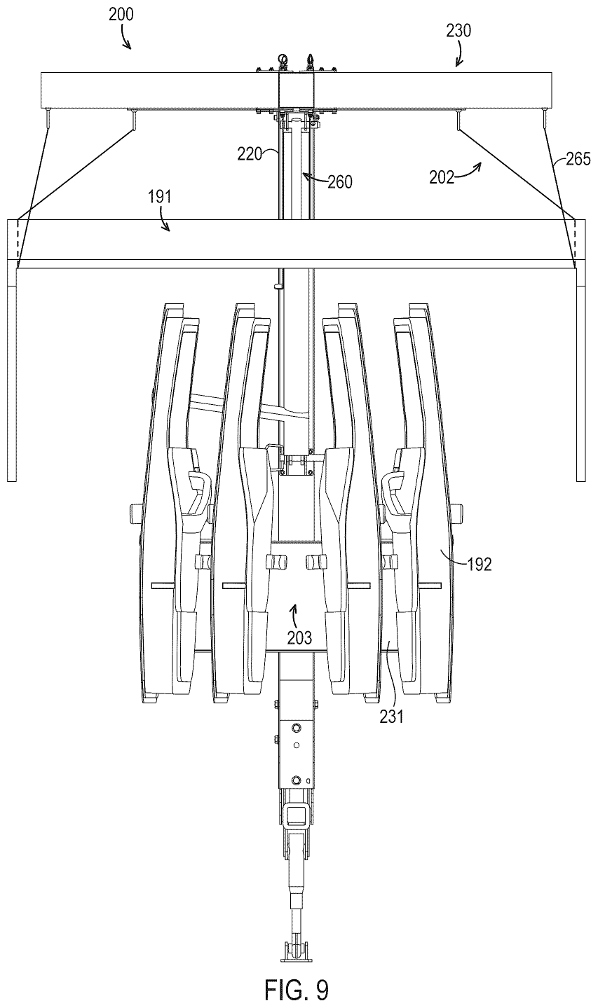

The reader can see in FIG. 9 that bracket 231 supports four removable doors. Door coupler 235 defines four sets of vertically aligned receiver holes 292 with two of the receiver holes of one vertically aligned set visible in FIGS. 8 and 9. The three additional sets of vertically aligned receiver holes are obscured in FIGS. 7-9 by retainer 233 and bracket 231. In other examples, the brackets may define additional or fewer receiver holes and correspondingly support additional or fewer doors.

In the example shown in FIGS. 7-9, door support assembly 203 includes two retainers 233 for selectively securing removable doors 192 on bracket 231. In some examples, a single retainer that extends across the bracket is used instead of two separate retainers as shown in FIGS. 7-9. Retainers 233 cooperate with bracket 231 and locking members, such as padlocks, to restrict removable doors 192 from being removed from bracket 231 without authorization.

As indicated by the arrow in FIG. 7, each retainer 233 is movably supported on bracket 231. In particular, retainer 233 is configured to move between a lock position and an access position relative to bracket 231.

In the lock position shown in FIG. 7, retainer 233 overlies an upper receiver hole 232. In examples where the door coupler includes vertical pins instead of receiver holes, the retainer would overlie the vertical pins in the lock position. Retainer 233 overlying receiver hole 232 functions to retain a hinge pin of removable door 192 received in receiver hole 232. Retaining a hinge pin of removable door 192 within receiver hole 232 with retainer 233 restricts removable door 192 from being dismounted from bracket 231.

In the access position, retainer 233 is offset from receiver hole 232. In examples where the door coupler includes vertical pins instead of receiver holes, the retainer would be offset from the vertical pins in the access position. Retainer 233 being offset from receiver hole 232 allows a hinge pin of removable door 192 to be removed from receiver hole 232. Allowing the hinge pin to be removed from receiver hole 232 enables removable door 192 to be dismounted from bracket 231. Removable door 192 can also be mounted to bracket 231 by inserting the hinge pin in receiver hole 232 when retainer 233 is in the access position.

As shown in FIGS. 7 and 8, retainer 233 defines a second lock hole 234. Second lock hole 234 overlies and is aligned with a first lock hole (not pictured) defined in bracket 231 when retainer 233 is in the lock position.

The first lock hole and second lock hole 234 are adapted to concurrently receive a lock member, such as a shackle of a lock, when they are aligned with each other. When the lock holes are aligned with the retainer in the lock position and a lock member extended through the lock holes, retainer 233 is restricted from moving away from the lock position. When retainer 233 is restricted to the lock position by a lock member extending through second lock hole 234 and the first lock hole defined in bracket 231, one is prevented from dismounting removable door 192 until the lock member is removed.

### Third Embodiment

Turning attention to FIG. 10, a third example of a lift apparatus, lift apparatus 300, will now be described. As can be seen in FIG. 10, lift apparatus 300 includes a frame 301, a lift mechanism 302, and a door support assembly 303.

A distinction between lift apparatus 300 and lift apparatus 100 is that lift mechanism 302 includes a ratchet strap mechanism 360 for selectively raising and lowering removable top 191. Ratchet strap mechanism 360 couples to lift points 338 of frame 301. As shown in FIG. 10, lift points 338 define rings coupled to boom 330.

As shown in FIG. 10, ratchet strap mechanism 360 includes an elongate tension bearing member 365, cleats 361, ratchet mechanisms 367, and couplers 368. The reader can see in FIG. 10 that elongate tension bearing member 365 is routed underneath removable top 191. Elongate tension bearing member 365 is a strap and is coupled to couplers 368 at opposite ends of strap 365. Couplers 368 couple opposite ends of strap 365 to mounting points 338.

Cleats 361 are mounted to ratchet mechanisms 367 and selectively engage strap 365 to restrict strap 365 from moving relative to ratchet mechanisms 367. Ratchet mechanisms 367 selectively wind and unwind strap 365 around spools to decrease and increase, respectively, the effective length of strap 365. Decreasing the effective length of strap 365 with ratchet mechanism 367 and cleat 361 functions to lift removable top 191. Increasing the effective length of strap 365 by disengaging cleat 361 and allowing strap 365 to unwind in ratchet mechanism 367 lowers removable top 191.

The reader should understand that ratchet mechanisms are not necessary to utilize a cleat-based lift system similar to the one shown in FIG. 10. For example, a lift mechanism without a ratchet mechanism would operate satisfactorily by manually decreasing or increasing the effective length of the strap and fixing the effective length with a cleat. The optional ratchet mechanisms shown in FIG. 10 simply provide a convenient means with mechanical advantage to selectively decrease the length of the strap under load from the removable top.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A lift apparatus for selectively lifting and storing removable components of a convertible vehicle, comprising:
a frame configured to removably mount to a tow hitch of a towing vehicle, the frame including:
a base configured to removably mount to the tow hitch;
a post extending vertically from the base; and
a boom pivotally mounted to the post and configured to pivot between a travel position where the boom is aligned with the post and a lift position where the boom extends transverse to the post; and
a lift mechanism operatively supported on the frame and configured to selectively lift a removable top of the convertible vehicle.

2. The lift apparatus of claim 1, wherein the base defines a base tongue adapted to insert into a tow hitch recess of the tow hitch to selectively couple the base to the tow hitch.

3. The lift apparatus of claim 2, wherein the base includes a receiver hitch mounted to the base tongue, the receiver hitch configured to receive a towbar or a ball mount to selectively link the convertible vehicle to the towing vehicle.

4. The lift apparatus of claim 1, wherein:
the boom operatively couples to the removable top of the convertible vehicle; and
moving the boom vertically lifts the removable top of the convertible vehicle.

5. The lift apparatus of claim 4, wherein the lift mechanism includes an actuator configured to selectively move the boom vertically to lift the removable top of the convertible vehicle.

6. The lift apparatus of claim 1, wherein:
the lift mechanism includes:
an elongate tension bearing member supported from the boom and operatively coupled to the removable top of the convertible vehicle; and
a cleat coupled to the elongate tension bearing member and configured to fix the effective length of the elongate tension bearing member; and
selectively shortening the effective length of the elongate tension bearing member with the cleat lifts the removable top of the convertible vehicle.

7. The lift apparatus of claim 1, wherein:
the lift mechanism includes:
a winch operatively supported on the frame and including a spool; and
a cable having a first end coupled to the winch and a second end opposite the first end and operatively coupled to the removable top of the convertible vehicle;
a selected portion of the cable is wound around the spool; and
rotating the spool to wind more of the cable around the spool lifts the removable top of the convertible vehicle relative to the convertible vehicle.

8. The lift apparatus of claim 7, wherein the boom includes a pulley supporting the cable.

9. The lift apparatus of claim 7, wherein:
the frame includes a winch arm pivotally mounted to the post;
the winch is supported on the winch arm; and
the winch arm is configured to pivot to a stowed position where the winch arm is parallel to the post.

10. The lift apparatus of claim 1, wherein the lift mechanism includes an elongate tension bearing member configured to selectively engage the removable top of the convertible vehicle.

11. The lift apparatus of claim 1, wherein the boom includes an eye defining a mounting point configured to support a removable top of the convertible vehicle independent of the lift mechanism.

12. The lift apparatus of claim 1, wherein the boom defines multiple, spaced lift points.

13. The lift apparatus of claim 12, wherein the boom includes:
a primary member extending longitudinally from the post, the primary member having a first lateral side and a second lateral side opposite the first lateral side;
a first cross member mounted to the first lateral side of the primary member and extending laterally from the primary member;
a second cross member mounted to the second lateral side of the primary member at the same longitudinal position on the primary member as the first cross member, the second cross member extending laterally from the primary member;
a third cross member mounted to the first lateral side of the primary member and longitudinally spaced from the first cross member, the third cross member extending laterally from the primary member; and
a fourth cross member mounted to the second lateral side of the primary member and longitudinally spaced from the second cross member, the fourth cross member extending laterally from the primary member.

14. The lift apparatus of claim 13, wherein the lift mechanism includes:
a first cable operatively supported by the first cross member distal the primary member and adapted to operatively couple to the removable top of the convertible vehicle;
a second cable operatively supported by the second cross member distal the primary member and adapted to operatively couple to the removable top of the convertible vehicle;
a third cable operatively supported by the third cross member distal the primary member and adapted to operatively couple to the removable top of the convertible vehicle; and
a fourth cable operatively supported by the fourth cross member distal the primary member and adapted to operatively couple to the removable top of the convertible vehicle.

15. The lift apparatus of claim 13, wherein the first cross member, the second cross member, and third cross member, and the fourth cross member are pivotally mounted to the primary member.

16. The lift apparatus of claim 1, further comprising a door support assembly pivotally mounted to the post and adapted to support a removable door when the door support assembly is pivoted to extend transverse to the post.

17. The lift apparatus of claim 16, wherein the door support assembly includes:
a door support beam; and
a bracket mounted to the door support beam, the bracket being configured to retain and support from below a window frame of the removable door placed thereon.

18. The lift apparatus of claim 1, wherein:
the lift apparatus further comprises a door support assembly configured to support a removable door selectively removed from the convertible vehicle;
the door support assembly includes a bracket selectively mounted to the post;
the bracket includes a door coupler configured to couple with the removable door; and
the bracket supports the removable door when the removable door is selectively coupled with the door coupler.

19. The lift apparatus of claim 18, wherein:
the door support assembly includes a retainer movably supported on the bracket;
the retainer is configured to move between a lock position and an access position;
the retainer overlies the door coupler to restrict a removable door from being dismounted from the bracket in the lock position; and
the retainer is offset from the door coupler in the access position to allow a removable door to be dismounted from the bracket.

20. The lift apparatus of claim 19, wherein:
the bracket defines a first lock hole;
the retainer defines a second lock hole aligned with the first lock hole when the retainer is in the lock position; and
the first lock hole and the second lock hole are adapted to concurrently receive a lock member when aligned with the retainer in the lock position to selectively restrict the retainer from moving away from the lock position.
